(19) United States
(12) Patent Application Publication
(10) Pub. No.: US 2026/0203448 A1
(43) Pub. Date: Jul. 16, 2026

(54) SYSTEMS AND METHODS FOR VALIDATING FILE TYPES

(71) Applicant: Capital One Services, LLC, McLean, VA (US)

(72) Inventors: Terence Goggin, Bethesda, MD (US); Jon B. Bellman, JR., Little Elm, TX (US)

(21) Appl. No.: 19/025,420

(22) Filed: Jan. 16, 2025

(51) Int. Cl. G06F 21/64

(52) U.S. Cl. CPC G06F 21/64

(57) ABSTRACT

Disclosed embodiments may include a method for validating file types by receiving an uploaded file having a purported file type, performing a first analysis of the uploaded file using a multi-purpose file type identification tool, and performing a second analysis of the uploaded file. The second analysis of the uploaded file can be performed by: fetching, based on the purported file type, a set of file analysis programs from a plurality of file analysis programs, receiving a plurality of test results, and determining a final test result by aggregating the plurality of test results. Next, responsive to determining, based on the final test result, that the uploaded file is not consistent with the purported file type, the method can execute a security action on the uploaded file.

### FIELD

The disclosed technology relates to systems and methods for validating file types. Specifically, this disclosed technology relates to detecting malformed files based on their corresponding file type by validating the file types using a set of file analysis programs.

### BACKGROUND

Detecting a corrupted, malformed or malware-infested file based on a file type of the file can be difficult. Files contain headers that represent purported file types, but corrupted files may have an actual file type that differs from the purported file type. Detecting this difference can be challenging, even though there are standards for file types. There are various interpretations of the file type standards which has resulted in a plurality of implementations of each standard. As a result, conventional, available methods that determine if a file actually has the corresponding, purported file type can be inaccurate due to the various implementations of file type standards.

Accordingly, there is a need for improved systems and methods for validating file types. Embodiments of the present disclosure are directed to this and other considerations.

### SUMMARY

Disclosed embodiments may include a system for validating file types. The system may include one or more processors, and memory in communication with the one or more processors and storing instructions that, when executed by the one or more processors, are configured to cause the system to validate file types by receiving a file having a purported file type, performing a first analysis of the provided file using a multi-purpose file type identification tool, and responsive to the first analysis determining that the provided file is not inconsistent with the purported file type, performing a second analysis of the provided file. The second analysis of the uploaded file can be performed by: fetching, based on the purported file type, a set of file analysis programs from a plurality of file analysis programs, responsive to analyzing the uploaded file using the set of file analysis programs, receiving a plurality of test results, and determining a final test result by aggregating the plurality of test results. Each test result of the plurality of test results can correspond to an output of each file analysis program of the set of file analysis programs. Next, responsive to determining, based on the final test result, that the uploaded file is not consistent with the purported file type, the stored instructions, when executed by the one or more processors, can be further configured to execute a security action on the uploaded file.

Disclosed embodiments may include a system for validating file types. The system may include one or more processors, and memory in communication with the one or more processors and storing instructions that, when executed by the one or more processors, are configured to cause the system to validate file types by receiving, via an application (such as a mobile check deposit application, a financial document application, or transactional document application) operating on a user device, an uploaded image having a purported file type in association with a request to deposit a check, performing a first analysis of the uploaded image using a multi-purpose file type identification tool, and responsive to the first analysis determining that the uploaded image is not inconsistent with the purported file type, performing a second analysis of the uploaded image using a set of file analysis programs. Performing the second analysis can include: fetching, based on the purported file type, the set of file analysis programs from a plurality of file analysis programs and responsive to analyzing the uploaded file using the set of file analysis programs, receiving a plurality of test results. Each test result of the plurality of test results can correspond to an output of each file analysis program of the set of file analysis programs. Next, performing the second analysis can include determining a final test result by aggregating the plurality of test results. Then, the stored instructions, when executed by the one or more processors can be further configured to, in response to determining, based on a final output of the set of file analysis programs, that the uploaded image is not consistent with the purported file type, reject the request to deposit the check.

Disclosed embodiments may include a system for validating file types. The system may include one or more processors, and memory in communication with the one or more processors and storing instructions that, when executed by the one or more processors, are configured to cause the system to validate file types by receiving, via a mobile check deposit application operating on a user device, an uploaded image having a purported file type in association with a request to deposit a check and performing a first analysis of the uploaded image using a multi-purpose file type identification tool. Then, the stored instructions, when executed by the one or more processors can be further configured to, in response to the first analysis determining that the uploaded image is not inconsistent with the purported file type, performing a second analysis of the uploaded image using a set of file analysis programs, and responsive to determining, based on a final output of the set of file analysis programs, that the uploaded image is not consistent with the purported file type, rejecting the file and halting any further processing of it.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for validating file types in accordance with certain embodiments of the disclosed technology.

FIG. 2 is a flow diagram illustrating an exemplary method for validating file types in accordance with certain embodiments of the disclosed technology.

FIG. 3 is block diagram of an example file type validation system used to provide validating file types, according to an example implementation of the disclosed technology.

FIG. 4 is block diagram of an example system that may be used to provide validating file types, according to an example implementation of the disclosed technology.

FIG. 5 is a flow diagram illustrating an exemplary method for validating file types in accordance with certain embodiments of the disclosed technology.

### DETAILED DESCRIPTION

Examples of the present disclosure relate to systems and methods for validating file types. More particularly, the disclosed technology relates to validating file types by analyzing a file using a set of file analysis programs to efficiently and accurately execute a security action on the file based on the test results from the analysis. The systems and methods described herein improve, in some instances, the operation of computers and technology. The present disclosure details detecting abnormalities within files to isolate corrupted and invalid data by validating the file type of the file. This, in some examples, may involve using a set of analysis programs to dynamically detect corrupted files, which improves the security of computers and technology. Using a computer system configured in this way may allow the system to quarantine the file to secure a computing system or network. This is a clear advantage and improvement over prior technologies that fail to accurately validate file types. The present disclosure solves this problem by accurately verifying the file type of a file regardless of various implementations of file standards. Overall, the systems and methods disclosed have significant practical applications in the malware detection field because of the noteworthy improvements of the detection of corrupt files, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

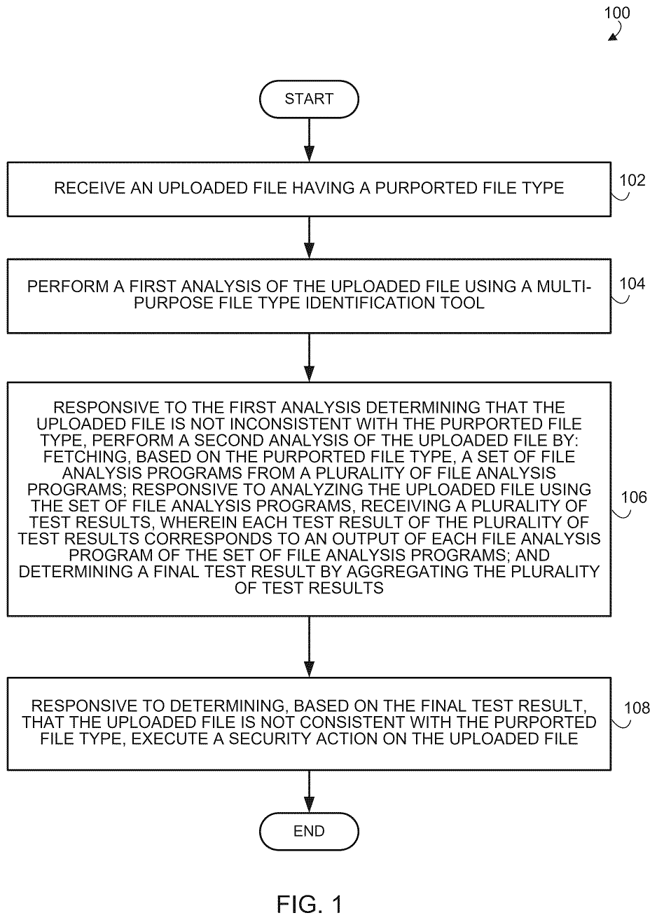

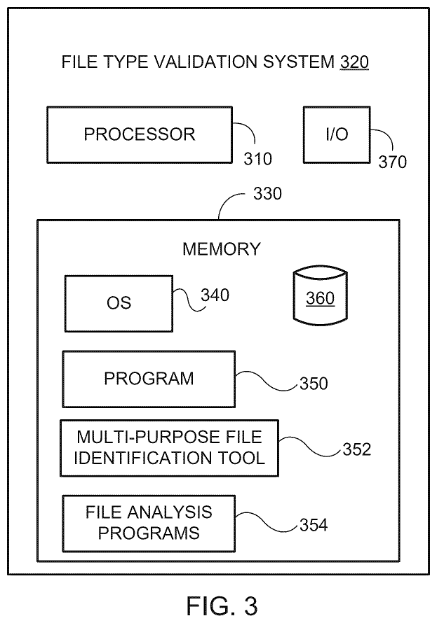

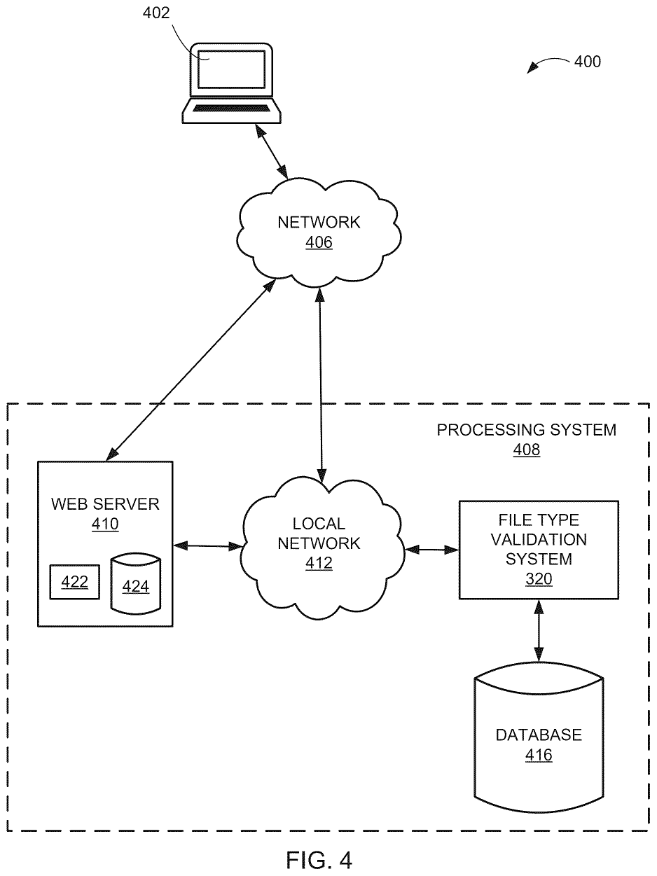

FIG. 1 is a flow diagram illustrating an exemplary method 100 for validating file types, in accordance with certain embodiments of the disclosed technology. The steps of method 100 may be performed by one or more components of the system 400 (e.g., file type validation system 320 or web server 410 of processing system 408 or user device 402), as described in more detail with respect to FIGS. 3 and 4. It should be understood that certain embodiments of the disclosed technology may omit one or more blocks as being optional.

In block 102, the file type validation system 320 may receive an uploaded file having a purported file type. In some embodiments, the purported file type can be a .jpeg file type, a .tiff file type, a .heic file type, a .png file type, a .gif file type, a .pdf file type, a .bmp file type, a .psd file type, a .ai file type, or a .csv file type. In some embodiments, the uploaded file can be a transactional document (such as tax documents), a firmware package, a financial document (such as bank statements), or a check. The file type validation system 320 may receive the uploaded file from the user device 402.

In block 104, the file type validation system 320 may perform a first analysis of the uploaded file using a multi-purpose file type identification tool 352. In some embodiments, the multi-purpose file type identification tool 352 can be a Unix's file utility. The file type validation system 320 can execute the Unix's file utility in some Unix and Mac systems. In other embodiments, the multi-purpose file type identification tool 352 can be any computer tool that is configured to perform operations on files to identify the file types of the files. The multi-purpose file type identification tool 352 can also be a file utility native to a computing system known in the art that is configured to perform operations on files to identify the file types of the files. In response to the file type validation system 320 determining, based on the first analysis, that the uploaded file is consistent with the purported file type, the file type validation system 320 may move to block 106.

In block 106, the file type validation system 320 may perform a second analysis of the uploaded file by fetching, based on the purported file type, a set of file analysis programs 354 from a plurality of file analysis programs 354. In some embodiments, the file type validation system 320 can retrieve or access the plurality of file analysis programs 354 from the file type validation system database 360 and the plurality of file analysis programs 354 can be software development libraries (self-contained tools that are tailored to a specific format of a file type standard). At least one or more of the plurality of file analysis programs 354 can be configured to parse file data associated with the uploaded file to generate parsed file data, and to determine header characteristics of the parsed file data. The header characteristics can include a number of headers in the parsed file data, an identification of one or more headers in the parsed file data, a placement of one or more headers in the parsed file data, or combinations thereof. In some embodiments, at least one or more of the plurality of file analysis programs can be configured to generate an output based on a comparison of the header characteristics to a predetermined header expectation associated with the file analysis program. The output of at least one or more of the plurality of file analysis programs 354 can include: a binary indication of whether the uploaded file is of a type that matches the purported file type (e.g., true or false match), a confidence score representing a level of confidence that the uploaded file is of a type that matches the purported file type, an error message indicating that the file analysis program crashed when processing the uploaded file, an exit status code indicating the uploaded file was abnormal, a message, or combinations thereof.

In some embodiments, the file type validation system 320 may perform the second analysis of the uploaded file using the plurality of file analysis programs 354 by processing the uploaded file using each file analysis program of the set of file analysis programs. In response to analyzing or processing the uploaded file using the set of file analysis programs 354, the file type validation system 320 may receive a plurality of test results. The file type validation system 320 may receive each of the plurality of test results from each corresponding plurality of file analysis programs 354 or from the set of file analysis programs 354. Each of the plurality of test results can be an output providing an indication of whether the uploaded file is consistent with the purported file type. Then the file type validation system 320 may generate the final output or final test result of the plurality of file analysis programs 354 by aggregating outputs of each file analysis program of the plurality of file analysis programs 354 as outlined above.

The file type validation system 320 may determine the final output or the final test result by aggregating the plurality of test results by normalizing each output of each file analysis program of the set of file analysis programs to a common scale to generate a plurality of scaled outputs, determining an average value of the plurality of scaled outputs, and in response to determining the average value of the plurality of scaled outputs does not exceed a predetermined threshold, determining that the uploaded file is not consistent with the purported file type. In some embodiments, the file type validation system 320 may use a mapping with predetermined weights based on one or more accuracy factors for each of the plurality of file analysis programs 354. Each of the plurality of file analysis programs 354 can be assigned a predetermined weight based on the one or more accuracy factors. The file type validation system 320 may assign the predetermined weights to each of the plurality of file analysis programs 354 based on an evaluation of the accuracy of the respective file analysis program. The file type validation system 320 may use the mapping of predetermined weights against the plurality of file analysis programs 354 to generate the plurality of scaled outputs. In some embodiments, the predetermined weights can be based on a type of the file analysis programs 354. In a non-limiting example, a file analysis program with PDFs can be given a predetermined weight higher than a second file analysis program that uses ImageMagick libraries.

In response to determining, based on the final test result, that the uploaded file is not consistent with the purported file type, in block 108, the file type validation system 320 may execute a security action on the uploaded file. In some embodiments, the security action can include rejecting the uploaded file, returning an error message, requesting a reupload of the uploaded file, requesting validation information from a user that submitted the uploaded file, storing the uploaded file in a quarantined storage location, or combinations thereof. In some embodiments, the file type validation system 320 may transmit a request to an application on the user device 402 requesting that a user reupload the file. In some embodiments, the application can be a mobile check deposit application and the file can be an image of a check.

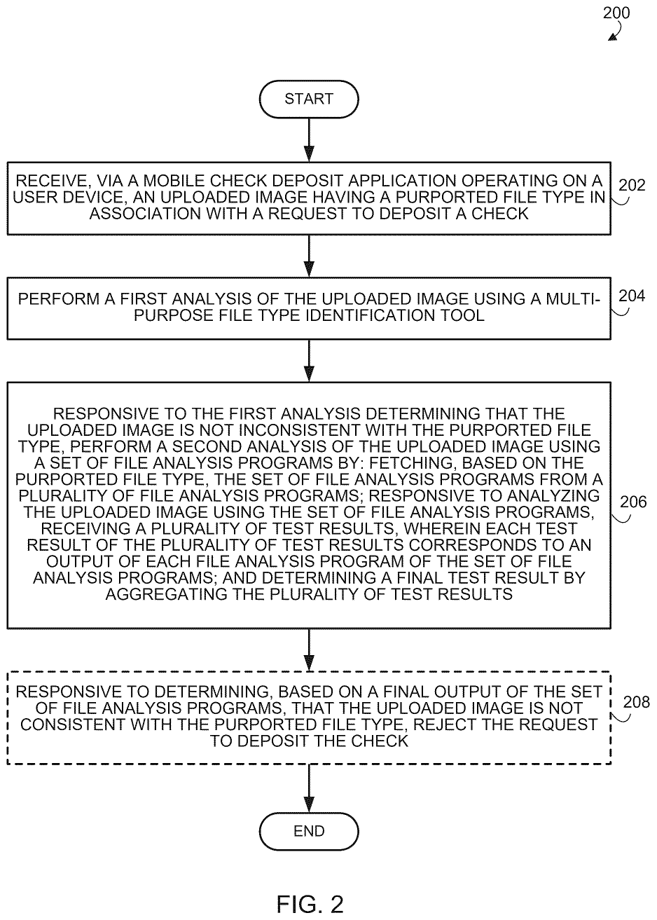

FIG. 2 is a flow diagram illustrating an exemplary method 200 for validating file types, in accordance with certain embodiments of the disclosed technology. The steps of method 200 may be performed by one or more components of the system 400 (e.g., file type validation system 320 or web server 410 of processing system 408 or user device 402), as described in more detail with respect to FIGS. 3 and 4. It should be understood that certain embodiments of the disclosed technology may omit one or more blocks as being optional.

Method 200 of FIG. 2 is similar to method 100 of FIG. 1. The descriptions of blocks 204, 206, and 208 in method 200 are similar to the respective descriptions of blocks 104, 106 and 108 of method 100 and are not repeated herein for brevity. However, block 202 is different from block 102 and is described below.

In block 202, the file type validation system 320 may receive, via a mobile check deposit application operating on a user device, an uploaded image having a purported file type in association with a request to deposit a check. Block 202 of method 200 is similar to block 102 of method 100, except the uploaded file can be the uploaded image in association with the request to deposit the check. The uploaded file can also be other transactional documents known in the art and can be received via a financial application.

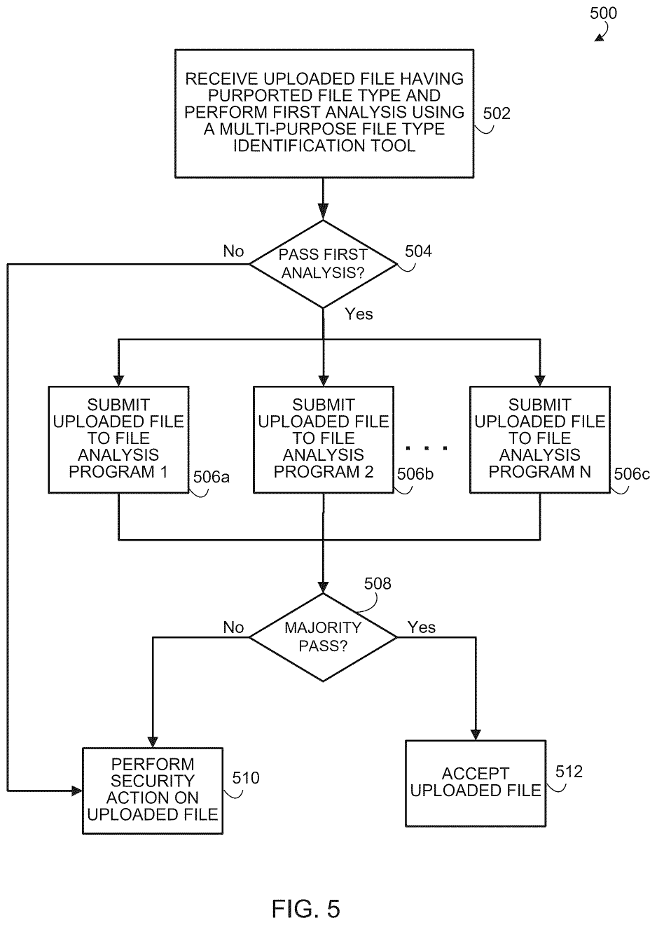

FIG. 5 is a flow diagram illustrating an exemplary method 500 for validating file types, in accordance with certain embodiments of the disclosed technology. The steps of method 500 may be performed by one or more components of the system 400 (e.g., file type validation system 320 or web server 410 of processing system 408 or user device 402), as described in more detail with respect to FIGS. 3 and 4. It should be understood that certain embodiments of the disclosed technology may omit one or more blocks as being optional.

Method 500 of FIG. 5 is similar to method 100 of FIG. 1. The descriptions of blocks 502 and 510 in method 500 are similar to the respective descriptions of blocks 102, 104, and 108 of method 100 and are not repeated herein for brevity. However, method 500 includes new blocks 504, 506a, 506b, 506c, 508, and 512 which are described below.

In block 504, the file type validation system 320 may determine if the uploaded file passed a first analysis of the multi-purpose file type identification tool 352. If the file type validation system 320 determines that the uploaded file passed the first analysis of the multi-purpose file type identification tool 352, the method 500 may move to blocks 506a, 506b, and/or 506c. The file type validation system 320 may determine that the uploaded file passed the first analysis of the multi-purpose file type identification tool 352 based on an output of the multi-purpose file type identification tool 352 that indicates that the uploaded file is consistent with the purported file type. If the file type validation system 320 determines that the uploaded file did not pass the first analysis of the multi-purpose file type identification tool 352 (e.g., the uploaded file is inconsistent with the purported file type), the file type validation system 320 may move to block 510.

In blocks 506a, 506b, 506c, the file type validation system 320 may submit the uploaded file to file analysis program 1, file analysis program 2,. and file analysis program n. The plurality of the file analysis programs 354 can include the file analysis program 1, the file analysis program 2, through the file analysis program n. In some embodiments, the file type validation system 320 can use an unlimited number of the plurality of the file analysis programs 354. File analysis program n can represent the last file analysis program to which the file type validation system 320 submits the uploaded file. As outlined in block 106 of method 100, each of the file analysis programs can return an output indicating whether the uploaded file is consistent with the purported file type (not repeated here for brevity).

In block 508, the file type validation system 320 may determine if the uploaded file passed a majority of a plurality of file analysis programs 354 by categorizing each of the outputs returned from the plurality of file analysis programs 354 as a pass (the respective file analysis program determined that the uploaded file is consistent with the purported file type) or fail (the respective file analysis program determined that the uploaded file is inconsistent with the purported file type). If the file type validation system 320 determines the uploaded file passed the majority of the plurality of file analysis programs 354, then the file type validation system 320 may move to block 512. Otherwise, the file type validation system 320 may move to block 510.

In block 512, the file type validation system 320 may accept the uploaded file. The file type validation system 320 can initiate a process or transaction using the uploaded file. In some embodiments, the uploaded file can be a check. The file type validation system 320 may generate a graphical user interface (GUI) comprising the acceptance of the uploaded file and transmit the GUI to the user device 402. The file type validation system 320 may initiate the transaction by transmitting the uploaded file to a financial server for processing (e.g., deposit the check, initiate a transfer). In some embodiments, the file type validation system 320 may modify the GUI to comprise a request for additional information for completion of the process or transaction. The file type validation system 320 may transmit the modified GUI to the user device 402. Then the file type validation system 320 may receive, via the user device 402 or the modified GUI, a response with the additional information. The file type validation system 320 may transmit the additional information to the financial server for further processing of the uploaded file.

FIG. 3 is a block diagram of an example file type validation system 320 used to validate file types according to an example implementation of the disclosed technology. According to some embodiments, the user device 402 and web server 410, as depicted in FIG. 4 and described below, may have a similar structure and components that are similar to those described with respect to file type validation system 320 shown in FIG. 3. As shown, the file type validation system 320 may include a processor 310, an input/output (I/O) device 370, a memory 330 containing an operating system (OS) 340, a program 350, a multi-purpose file identification tool 352, and file analysis programs 354. In certain example implementations, the file type validation system 320 may be a single server or may be configured as a distributed computer system including multiple servers or computers that interoperate to perform one or more of the processes and functionalities associated with the disclosed embodiments. In some embodiments file type validation system 320 may be one or more servers from a serverless or scaling server system. In some embodiments, the file type validation system 320 may further include a peripheral interface, a transceiver, a mobile network interface in communication with the processor 310, a bus configured to facilitate communication between the various components of the file type validation system 320, and a power source configured to power one or more components of the file type validation system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the file type validation system 320 may include one or more storage devices configured to store information used by the processor 310 (or other components) to perform certain functions related to the disclosed embodiments. In one example, the file type validation system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The file type validation system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the file type validation system 320 may include the memory 330 that may include one or more programs 350 to perform one or more functions of the disclosed embodiments. For example, in some embodiments, the file type validation system 320 may additionally manage dialogue and/or other interactions with the customer via a program 350.

The processor 310 may execute one or more programs 350 located remotely from the file type validation system 320. For example, the file type validation system 320 may access one or more remote programs that, when executed, perform functions related to disclosed embodiments.

The processor 310 may execute the multi-purpose file identification tool 352 located remotely from the file type validation system 320. For example, the file type validation system 320 may access one or more remote multi-purpose file identification tools that, when executed, perform functions related to disclosed embodiments.

The processor 310 may execute the file analysis programs 354 located remotely from the file type validation system 320. For example, the file type validation system 320 may access one or more file analysis programs 354 that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a file type validation system database 360 for storing related data to enable the file type validation system 320 to perform one or more of the processes and functionalities associated with the disclosed embodiments.

The file type validation system database 360 may include stored data relating to status data (e.g., average session duration data, location data, idle time between sessions, and/or average idle time between sessions) and historical status data. According to some embodiments, the functions provided by the file type validation system database 360 may also be provided by a database that is external to the file type validation system 320, such as the database 416 as shown in FIG. 4.

The file type validation system 320 may also be communicatively connected to one or more memory devices (e.g., databases) locally or through a network. The remote memory devices may be configured to store information and may be accessed and/or managed by the file type validation system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The file type validation system 320 may also include one or more I/O devices 370 that may comprise one or more interfaces for receiving signals or input from devices and providing signals or output to one or more devices that allow data to be received and/or transmitted by the file type validation system 320. For example, the file type validation system 320 may include interface components, which may provide interfaces to one or more input devices, such as one or more keyboards, mouse devices, touch screens, track pads, trackballs, scroll wheels, digital cameras, microphones, sensors, and the like, that enable the file type validation system 320 to receive data from a user (such as, for example, via the user device 402).

In examples of the disclosed technology, the file type validation system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The file type validation system 320 may contain programs that train, implement, store, receive, retrieve, and/or transmit one or more machine learning models. Machine learning models may include a neural network model, a large neural network, a large language model (LLM), a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The file type validation system 320 may be configured to adjust model parameters during training. Model parameters may include weights, coefficients, offsets, or the like. Training may be supervised or unsupervised.

The file type validation system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The file type validation system 320 may be configured to optimize statistical models using known optimization techniques.

The file type validation system 320 may also contain one or more prediction models. Prediction models may include statistical algorithms that are used to determine the probability of an outcome, given a set amount of input data, such as predicting the uploaded file is corrupted or not the purported file type. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the file type validation system may analyze information applying machine-learning methods.

While the file type validation system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the file type validation system 320 may include a greater or lesser number of components than those illustrated.

FIG. 4 is a block diagram of an example system of a processing system 408, according to an example implementation of the disclosed technology. The components and arrangements shown in FIG. 4 are not intended to limit the disclosed embodiments as the components used to implement the disclosed processes and features may vary. As shown, processing system 408 may interact with a user device 402 via a network 406. In certain example implementations, the processing system 408 may include a local network 412, a file type validation system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the processing system 408. In some embodiments, the user device 402 may include or incorporate electronic communication devices for hearing or vision impaired users.

According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 may be of any suitable type, including individual connections via the internet such as cellular or WiFi networks. In some embodiments, the network 406 may connect terminals, services, and mobile devices using direct connections such as RFID, NFC, Bluetooth™, BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The processing system 408 may be associated with and optionally controlled by one or more entities such as a business, corporation, individual, partnership, or any other entity that provides one or more of goods, services, and consultations to individuals such as customers. In some embodiments, the processing system 408 may be controlled by a third party on behalf of another business, corporation, individual, partnership. The processing system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the file type validation system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the processing system 408 to interact with one another and to connect to the network 406 for interacting with components in the system 400 environment. In some embodiments, the local network 412 may include an interface for communicating with or linking to the network 406. In other embodiments, certain components of the processing system 408 may communicate via the network 406, without a separate local network 406.

The processing system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access processing system 408 using the cloud computing environment. User device 402 may be able to access processing system 408 using specialized software. The cloud computing environment may eliminate the need to install specialized software on user device 402.

In accordance with certain example implementations of the disclosed technology, the processing system 408 may include one or more computer systems configured to compile data from a plurality of sources the file type validation system 320, web server 410, and/or the database 416. The file type validation system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

### EXAMPLE USE CASE

The following example use case describes an example of a typical user flow pattern. This section is intended solely for explanatory purposes and not in limitation.

In one example, a customer John needs to deposit a check by using his cell phone, a user device 402. Company, a banking company, can offer online services that John can utilize to complete the check deposit. To gain access to the account, John may send, via the user device 402, a login request with authentication information for his account to the file type validation system 320. The file type validation system 320 may then determine whether the authentication information matches data associated with an account belonging to John. The file type validation system 320, in response to determining that the authentication information matches at least a portion of the data associated with John's account, may authorize the user device 402 to access the account of the user.

The file type validation system 320 may then receive from John's cell phone, the user device 402, an image of a check for the mobile deposit. The purported file type of the image or uploaded file can be a .jpeg file type. The file type validation system 320 may perform a first analysis of the uploaded file using a multi-purpose file type identification tool. The file type validation system 320 may receive an output from the multi-purpose file type identification tool determining that the uploaded file is consistent with the purported file type. The file type validation system 320 may perform a second analysis of the uploaded file. The second analysis of the uploaded file can be performed by: fetching, based on the purported file type, a set of file analysis programs 354 from a plurality of file analysis programs 354. The file type validation system 320 may select the set of file analysis programs 354 from the plurality of file analysis programs 354 based on the file type of the uploaded file. The plurality of file analysis programs 354 can be software development libraries. Each of the set of file analysis programs 354 can return a plurality of test results to the file type validation system 320. The file type validation system 320 may then determine a final test result by aggregating the plurality of test results.

In this example, the plurality of test results can include: 1) file analysis program A of the set of file analysis programs 354 may return a binary result of pass indicating a consistency between the file type and the purported file type of the uploaded file, 2) file analysis program B of the set of file analysis programs may return a message indicating an inconsistency between the file type and the purported file type of the uploaded file (the file type validation system 320 can parse or categorize the message to indicate consistency or inconsistency by using natural language processors), 3) file analysis program C of the set of file analysis programs may return a confidence score representing an average level of confidence that the uploaded file is of a type that matches the purported file type, and 4) file analysis program D of the set of file analysis programs may return an error message indicating that the file analysis program crashed when processing the uploaded file. The file type validation system 320 can assign predetermined weights to each of the set of file analysis programs 354 (e.g., file analysis program A with a weight of 10, file analysis program B with a weight of 10, file analysis program C with a weight of 8, file analysis program D with a weight of 5). The file type validation system 320 can aggregate the outputs and determine a final test result by grouping consistency scores together (scored as 18 in this example), inconsistency scores together (scored as 10 in this example), and undetermined scores together (scored as 5 in this example). Based on the consistency scores being the highest score, the file type validation system 320 can determine there is consistency between the file type and the purported file type of the uploaded file. In other examples, the file type validation system 320 may take the majority of the results to determine if there is a consistency (e.g., two of the programs indicated consistency, one failure, and one undetermined; therefore the final result would be consistency).

Next, responsive to determining, based on the final test result, that the uploaded file is consistent with the purported file type, the file type validation system 320 may send a deposit request to initiate the mobile check deposit of funds to John's account. The file type validation system 320 may generate a GUI comprising the acceptance of the check and transmit the GUI to John's user device 402. The file type validation system 320 may initiate the transaction by transmitting the check to Company's server for processing. In some embodiments, the file type validation system 320 may modify the GUI to comprise a request for additional information for completion of the mobile deposit. The file type validation system 320 may transmit the modified GUI to John's user device 402. Then the file type validation system 320 may receive, via John's user device 402, a response with the additional information. The file type validation system 320 may transmit the additional information to the Company's server for further processing of the mobile deposit. In other embodiments, the file type validation system 320 may have access to the additional information needed for the mobile deposit via the Company's server. The additional information can include John's banking information, address, phone number, or other fields required to complete the mobile deposit of funds.

In some examples, disclosed systems or methods may involve one or more of the following clauses:

Clause 1: A system comprising: one or more processors; and a memory in communication with the one or more processors and storing instructions that, when executed by the one or more processors, are configured to cause the system to: receive an uploaded file having a purported file type; perform a first analysis of the uploaded file using a multi-purpose file type identification tool; responsive to the first analysis determining that the uploaded file is not inconsistent with the purported file type, perform a second analysis of the uploaded file by: fetching, based on the purported file type, a set of file analysis programs from a plurality of file analysis programs; responsive to analyzing the uploaded file using the set of file analysis programs, receiving a plurality of test results, wherein each test result of the plurality of test results corresponds to an output of each file analysis program of the set of file analysis programs; and determining a final test result by aggregating the plurality of test results; and responsive to determining, based on the final test result, that the uploaded file is not consistent with the purported file type, execute a security action on the uploaded file.

Clause 2: The system of clause 1, wherein the purported file type comprises a file type selected from the group consisting of: a .jpeg file type; a .tiff file type; a .heic file type; a .png file type; a .gif file type; a .pdf file type; a .bmp file type; a .psd file type; a .ai file type; and a .csv file type.

Clause 3: The system of clause 1, wherein the multi-purpose file type identification tool comprises Unix's file utility.

Clause 4: The system of clause 1, wherein one or more of the plurality of file analysis programs is configured to: parse file data associated with the uploaded file to generate parsed file data; and determine header characteristics comprising one or more of: a number of headers in the parsed file data; an identification of one or more headers in the parsed file data; and a placement of one or more headers in the parsed file data.

Clause 5: The system of clause 4, wherein each of the one or more of the plurality of file analysis programs are configured to generate an output based on a comparison of the header characteristics to a predetermined header expectation associated with the file analysis program; wherein the output of each of the one or more of the plurality of file analysis programs comprises one or more of: a binary indication of whether the uploaded file is of a type that matches the purported file type; a confidence score representing a level of confidence that the uploaded file is of a type that matches the purported file type; an error message indicating that the file analysis program crashed when processing the uploaded file; an exit status code; and a message.

Clause 6: The system of clause 5, wherein determining a final test result by aggregating the plurality of test results comprises: normalizing each output of each file analysis program of the set of file analysis programs to a common scale to generate a plurality of scaled outputs; determining an average value of the plurality of scaled outputs; and responsive to determining the average value of the plurality of scaled outputs does not exceed a predetermined threshold, determining that the uploaded file is not consistent with the purported file type.

Clause 7: The system of clause 4, wherein the plurality of file analysis programs comprise software development libraries.

Clause 8: The system of clause 1, wherein the security action comprises one or more of: rejecting the uploaded file; returning an error message and requesting a reupload of the uploaded file; requesting validation information from a user that submitted the uploaded file; and storing the uploaded file in a quarantined storage location.

Clause 9: A system comprising: one or more processors; and a memory in communication with the one or more processors and storing instructions that, when executed by the one or more processors, are configured to cause the system to: receive, via a mobile check deposit application operating on a user device, an uploaded image having a purported file type in association with a request to deposit a check; perform a first analysis of the uploaded image using a multi-purpose file type identification tool; responsive to the first analysis determining that the uploaded image is not inconsistent with the purported file type, perform a second analysis of the uploaded image using a set of file analysis programs by: fetching, based on the purported file type, the set of file analysis programs from a plurality of file analysis programs; responsive to analyzing the uploaded image using the set of file analysis programs, receiving a plurality of test results, wherein each test result of the plurality of test results corresponds to an output of each file analysis program of the set of file analysis programs; and determining a final test result by aggregating the plurality of test results; and responsive to determining, based on a final output of the set of file analysis programs, that the uploaded image is not consistent with the purported file type, reject the request to deposit the check.

Clause 10: The system of clause 9, wherein the multi-purpose file type identification tool comprises Unix's file utility.

Clause 11: The system of clause 9, wherein one or more of the plurality of file analysis programs is configured to: parse image data associated with the uploaded image to generate parsed image data; and determine header characteristics comprising one or more of: a number of headers in the parsed image data; an identification of one or more headers in the parsed image data; and a placement of one or more headers in the parsed image data.

Clause 12: The system of clause 11, wherein each of the one or more of the plurality of file analysis programs are configured to generate an output based on a comparison of the header characteristics to a predetermined header expectation associated with the file analysis program; wherein the output of each of the one or more of the plurality of file analysis programs comprises one or more of: a binary indication of whether the uploaded image is of a type that matches the purported file type; a confidence score representing a level of confidence that the uploaded image is of a type that matches the purported file type; an error message indicating that the file analysis program crashed when processing the uploaded image; an exit status code; and a message.

Clause 13: The system of clause 12, wherein determining a final test result by aggregating the plurality of test results comprises: normalizing each output of each file analysis program of the set of file analysis programs to a common scale to generate a plurality of scaled outputs; determining an average value of the plurality of scaled outputs; and responsive to determining the average value of the plurality of scaled outputs does not exceed a predetermined threshold, determining that the uploaded image is not consistent with the purported file type.

Clause 14: The system of clause 11, wherein the plurality of file analysis programs comprise software development libraries.

Clause 15: A system comprising: one or more processors; and a memory in communication with the one or more processors and storing instructions that, when executed by the one or more processors, are configured to cause the system to: receive, via a mobile check deposit application operating on a user device, an uploaded image having a purported file type in association with a request to deposit a check; perform a first analysis of the uploaded image using a multi-purpose file type identification tool; responsive to the first analysis determining that the uploaded image is not inconsistent with the purported file type, perform a second analysis of the uploaded image using a set of file analysis programs; and responsive to determining, based on a final output of the set of file analysis programs, that the uploaded image is not consistent with the purported file type, reject the request to deposit the check.

Clause 16: The system of clause 15, wherein the multi-purpose file type identification tool comprises Unix's file utility.

Clause 17: The system of clause 15, wherein one or more of the set of file analysis programs is configured to: parse image data associated with the uploaded image to generate parsed image data; and determine header characteristics comprising one or more of: a number of headers in the parsed image data; an identification of one or more headers in the parsed image data; and a placement of one or more headers in the parsed image data.

Clause 18: The system of clause 15, wherein performing the second analysis of the uploaded image using the set of file analysis programs comprises: processing the uploaded image using each file analysis program of the set of file analysis programs; receiving, from each file analysis program of the set of file analysis programs, an output providing an indication of whether the uploaded image is consistent with the purported file type; and generating the final output of the set of file analysis programs by aggregating outputs of each file analysis program of the set of file analysis programs.

Clause 19: The system of clause 15, wherein the set of file analysis programs comprise software development libraries.

Clause 20: The system of clause 15, wherein the instructions are further configured to cause the system to: responsive to determining, based on a final output of the set of file analysis programs, that the uploaded image is not consistent with the purported file type, transmit a request to the mobile check deposit application on the user device requesting that a user reupload an image of the check.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all, or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
a memory in communication with the one or more processors and storing instructions that, when executed by the one or more processors, are configured to cause the system to:
receive an uploaded file having a purported file type;
perform a first analysis of the uploaded file using a multi-purpose file type identification tool;
responsive to the first analysis determining that the uploaded file is consistent with the purported file type, perform a second analysis of the uploaded file by:
fetching, based on the purported file type, a set of file analysis programs from a plurality of file analysis programs;
responsive to analyzing the uploaded file using the set of file analysis programs, receiving a plurality of test results, wherein each test result of the plurality of test results corresponds to an output of each file analysis program of the set of file analysis programs; and
determining a final test result by aggregating the plurality of test results; and
responsive to determining, based on the final test result, that the uploaded file is not consistent with the purported file type, execute a security action on the uploaded file.

2. The system of claim 1, wherein the purported file type comprises a file type selected from the group consisting of:
a .jpeg file type;
a .tiff file type;
a .heic file type;
a .png file type;
a .gif file type;
a .pdf file type;
a .bmp file type;
a .psd file type;
a .ai file type; and
a .csv file type.

3. The system of claim 1, wherein the multi-purpose file type identification tool comprises Unix's file utility.

4. The system of claim 1, wherein one or more of the plurality of file analysis programs is configured to:
parse file data associated with the uploaded file to generate parsed file data; and
determine header characteristics comprising one or more of:
a number of headers in the parsed file data;
an identification of one or more headers in the parsed file data; and
a placement of one or more headers in the parsed file data.

5. The system of claim 4, wherein each of the one or more of the plurality of file analysis programs are configured to generate an output based on a comparison of the header characteristics to a predetermined header expectation associated with the file analysis program; wherein the output of each of the one or more of the plurality of file analysis programs comprises one or more of:
a binary indication of whether the uploaded file is of a type that matches the purported file type;
a confidence score representing a level of confidence that the uploaded file is of a type that matches the purported file type;
an error message indicating that the file analysis program crashed when processing the uploaded file;
an exit status code; and
a message.

6. The system of claim 5, wherein determining a final test result by aggregating the plurality of test results comprises:
normalizing each output of each file analysis program of the set of file analysis programs to a common scale to generate a plurality of scaled outputs;
determining an average value of the plurality of scaled outputs; and
responsive to determining the average value of the plurality of scaled outputs does not exceed a predetermined threshold, determining that the uploaded file is not consistent with the purported file type.

7. The system of claim 4, wherein the plurality of file analysis programs comprise software development libraries.

8. The system of claim 1, wherein the security action comprises one or more of:
rejecting the uploaded file;
returning an error message and requesting a reupload of the uploaded file;
requesting validation information from a user that submitted the uploaded file; and
storing the uploaded file in a quarantined storage location.

9. A system comprising:
one or more processors; and
a memory in communication with the one or more processors and storing instructions that, when executed by the one or more processors, are configured to cause the system to:
receive, via a mobile check deposit application operating on a user device, an uploaded image having a purported file type in association with a request to deposit a check;
perform a first analysis of the uploaded image using a multi-purpose file type identification tool;
responsive to the first analysis determining that the uploaded image is consistent with the purported file type, perform a second analysis of the uploaded image using a set of file analysis programs by:
fetching, based on the purported file type, the set of file analysis programs from a plurality of file analysis programs;
responsive to analyzing the uploaded image using the set of file analysis programs, receiving a plurality of test results, wherein each test result of the plurality of test results corresponds to an output of each file analysis program of the set of file analysis programs; and
determining a final test result by aggregating the plurality of test results; and
responsive to determining, based on a final output of the set of file analysis programs, that the uploaded image is not consistent with the purported file type, reject the request to deposit the check.

10. The system of claim 9, wherein the multi-purpose file type identification tool comprises Unix's file utility.

11. The system of claim 9, wherein one or more of the plurality of file analysis programs is configured to:
parse image data associated with the uploaded image to generate parsed image data; and
determine header characteristics comprising one or more of:
a number of headers in the parsed image data;
an identification of one or more headers in the parsed image data; and
a placement of one or more headers in the parsed image data.

12. The system of claim 11, wherein each of the one or more of the plurality of file analysis programs are configured to generate an output based on a comparison of the header characteristics to a predetermined header expectation associated with the file analysis program; wherein the output of each of the one or more of the plurality of file analysis programs comprises one or more of:
a binary indication of whether the uploaded image is of a type that matches the purported file type;
a confidence score representing a level of confidence that the uploaded image is of a type that matches the purported file type;
an error message indicating that the file analysis program crashed when processing the uploaded image;
an exit status code; and
a message.

13. The system of claim 12, wherein determining a final test result by aggregating the plurality of test results comprises:
normalizing each output of each file analysis program of the set of file analysis programs to a common scale to generate a plurality of scaled outputs;
determining an average value of the plurality of scaled outputs; and
responsive to determining the average value of the plurality of scaled outputs does not exceed a predetermined threshold, determining that the uploaded image is not consistent with the purported file type.

14. The system of claim 11, wherein the plurality of file analysis programs comprise software development libraries.

15. A system comprising:
one or more processors; and
a memory in communication with the one or more processors and storing instructions that, when executed by the one or more processors, are configured to cause the system to:
receive, via a mobile check deposit application operating on a user device, an uploaded image having a purported file type in association with a request to deposit a check;
perform a first analysis of the uploaded image using a multi-purpose file type identification tool;
responsive to the first analysis determining that the uploaded image is consistent with the purported file type, perform a second analysis of the uploaded image using a set of file analysis programs; and
responsive to determining, based on a final output of the set of file analysis programs, that the uploaded image is not consistent with the purported file type, reject the request to deposit the check.

16. The system of claim 15, wherein the multi-purpose file type identification tool comprises Unix's file utility.

17. The system of claim 15, wherein one or more of the set of file analysis programs is configured to:
parse image data associated with the uploaded image to generate parsed image data; and
determine header characteristics comprising one or more of:
a number of headers in the parsed image data;
an identification of one or more headers in the parsed image data; and
a placement of one or more headers in the parsed image data.

18. The system of claim 15, wherein performing the second analysis of the uploaded image using the set of file analysis programs comprises:
processing the uploaded image using each file analysis program of the set of file analysis programs;
receiving, from each file analysis program of the set of file analysis programs, an output providing an indication of whether the uploaded image is consistent with the purported file type; and
generating the final output of the set of file analysis programs by aggregating outputs of each file analysis program of the set of file analysis programs.

19. The system of claim 15, wherein the set of file analysis programs comprise software development libraries.

20. The system of claim 15, wherein the instructions are further configured to cause the system to:
responsive to determining, based on a final output of the set of file analysis programs, that the uploaded image is not consistent with the purported file type, transmit a request to the mobile check deposit application on the user device requesting that a user reupload an image of the check.
